(19) United States
(12) Patent Application Publication
(10) Pub. No.: US 2005/0051940 A1
(43) Pub. Date: Mar. 10, 2005

(54) Work stand

(75) Inventor: Mark Bensman, Rosh Ha'ayin (IL)

Correspondence Address: PILLSBURY WINTHROP, LLP, P.O. BOX 10500, MCLEAN, VA, 22102, US

(73) Assignee: Zag Industries, Ltd., Rosh Ha'Ayin (IL)

(21) Appl. No.: 10/654,923

(22) Filed: Sep. 5, 2003

(51) Int. Cl. B25B 1/02

(52) U.S. Cl. 269/139

(57) ABSTRACT

A work stand includes a base structure and a table structure movably mounted on the base structure to adjust the height of the table surface. A spring mechanism is operatively engaged with the table structure and operable to apply a force to the table structure which tends to raise the table structure to assist a raising movement with respect to the base structure. Steps are mounted on the base structure and are positioned generally under the table structure when the table structure is in an operative position. The table structure is movable into an access position in which the steps are exposed.

### BACKGROUND

1. Field of the Invention

The present invention relates to work stands. More specifically, the invention relates to multifunctional work stands operable as a work table or workbench that have a height adjustable work surface to support a workpiece at various heights. The invention also relates to work stands that have a work surface and steps that can support a standing worker above the ground.

2. Discussion of Related Art

Workers often use work stands, such as tables or benches, to support a workpiece that is being worked on. It is desirable to have a work stand that is adjustable in height so that different work pieces can be accommodated and different tasks can be carried out comfortably with the work stand. Typical work stands have table surfaces that can be raised or lowered by pulling or pressing on them to adjust the leg height. This is often awkward because the user must grasp the table surface and pull, for example, while forcing the legs to extend to adjust the relative height. If the table surface is heavy or the legs do not easily extend, this action can be difficult to accomplish.

Known work stands sometimes also include a horizontal cross bar or step to provide a resting surface for a user or to provide a weight bearing surface for a worker to stand on. As such work tables are typically not designed as step ladders, the step may not be sufficiently sturdy to function as a stepping stool or stable support.

It would be desirable to provide a work stand for which it is easy to adjust the height. It would also be desirable to provide a work stand that offered a stable stepping surface.

### SUMMARY OF THE INVENTION

Some of the aspects of the present invention may be embodied in a work stand comprising a base including at least two legs and a table structure supported by the base. The table structure includes a table top surface and a rigid support element. The rigid support element is movably coupled to at least one leg. A biasing mechanism is connected to the at least one leg and the rigid support element to urge the table structure to move generally vertically with respect to the base. A locking mechanism is connected to at least one of the rigid support elements and the leg to lock the table structure in a set position with respect to the base.

The work stand may further comprise a clamping assembly mounted to the table structure.

The work stand may also have at least two steps coupled to the base and positioned under the table top surface. The table top surface is tiltable to a position in which the steps are accessible to an upright user.

Other aspects of embodiments of the invention are directed to a work stand comprising a base including a plurality of support members, at least two of the support members being generally parallel and spaced apart, and a table structure supported by the base and including a table top surface. The table structure is pivotally mounted with respect to the base and movable between a work position and a step access position. At least two steps are supported between the spaced apart parallel support members. The steps have horizontal support surfaces positioned under the table top surface when the table structure is in the work position and all steps are accessible to an upright user when the table top is in the step access position to provide a stable weight bearing support surface.

The work table may include a support element that is connected to the base to allow selective movement between the table structure and the base. A biasing mechanism may be disposed between the support element and hollow support members to urge the table structure to move in a vertical direction with respect to the base.

Still further aspects of embodiments of the invention are directed to a work stand comprising a base structure constructed and arranged to stand in an upright position on a ground surface and a table structure having a table top surface configured to support a work piece and mounted on the base structure for raising and lowering movement through a range of operative table top positions with respect to the base structure to adjust the height of the table top surface with respect to the ground surface. A releasable table locking mechanism operatively engages with the table structure and is movable between a locking position in which the table locking mechanism releasably locks the table structure in an operative table top position and a releasing position in which the table structure can be raised and lowered through the range of operative table top positions thereof. A spring mechanism operatively engages with the table structure operable to apply a force to the table structure which tends to raise the table structure with respect to the base structure to assist a raising movement of the table structure with respect to the base structure. A lower step and an upper step are mounted on the base structure. The upper and lower steps are positioned generally under the table structure when the table structure is in an operative position. The table structure is movable into an access position in which the steps are exposed to enable a worker to climb up and down the steps and to stand on either step with an erect posture.

Other aspects, features, and advantages of the present invention are apparent from the following detailed description of the illustrated embodiment, the accompanying drawings, and the appended claims.

### BRIEF DESCRIPTION OF THE DRAWINGS

FIG. 1 shows a perspective view of a work stand in accordance with one illustrative embodiment of the present invention, a portion of a leg of the work stand being shown in cross-sectional view;

FIG. 2 is a view of the work stand similar to the view of FIG. 1 except showing a table structure of the work stand at a different height and showing a vise of the work stand in an open position.

FIG. 3 is a front elevational view of the work stand of FIG. 2;

FIG. 4 is a side elevational view of the work stand of FIG. 2 except showing a table structure of the work stand in a folded, access position;

FIG. 5 is an enlarged view of a portion of the work stand as indicated in FIG. 1;

FIG. 6 is an enlarged view of a portion of the work stand as indicated in FIG. 2; and

FIG. 7 is a side elevational view of the work stand in a folded storage position.

### DETAILED DESCRIPTION OF PREFERRED EMBODIMENTS

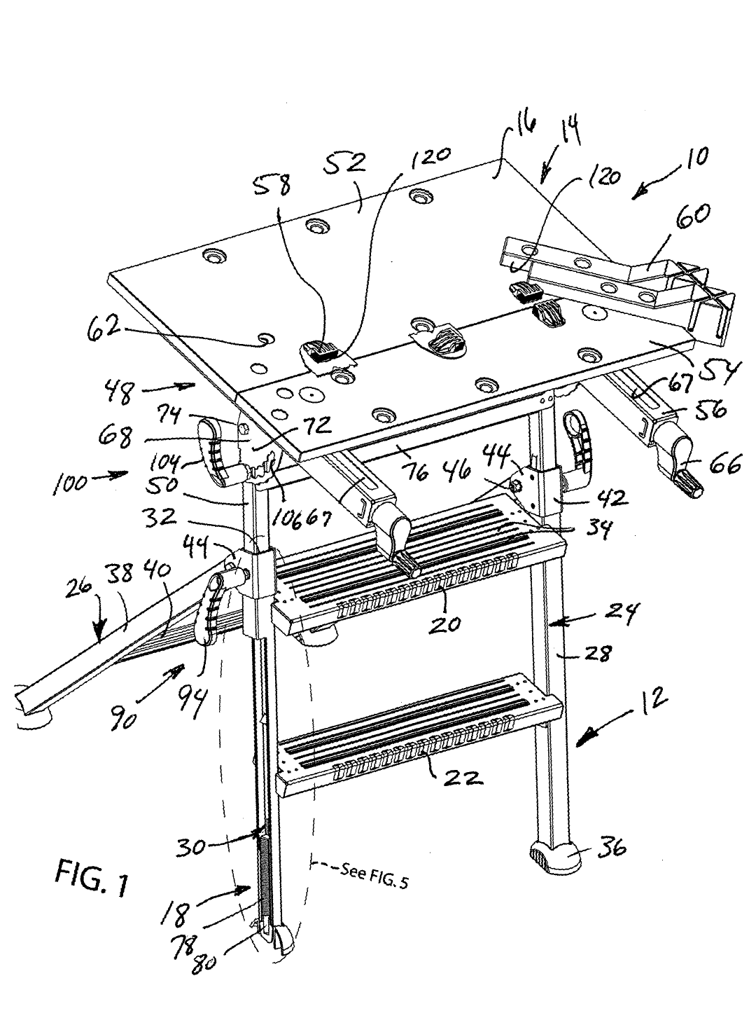

FIGS. 1-4 show an illustrative embodiment of a work stand 10 constructed according to principles of the present invention. The work stand 10 includes a base structure 12 and a table structure 14 having a table top surface 16 configured to support a workpiece. The table structure 14 is mounted on the base structure 12 for raising and lowering movement through a range of operative table top positions with respect to the base structure 12 to adjust the height of the table top surface 16 with respect to the ground surface. A spring mechanism 18 is operatively engaged with the table structure 14 and is operable to apply a force to the table structure 14 which tends to raise the table structure 14 with respect to the base structure 12 to assist a raising movement of the table structure 14 with respect to the base structure 12.

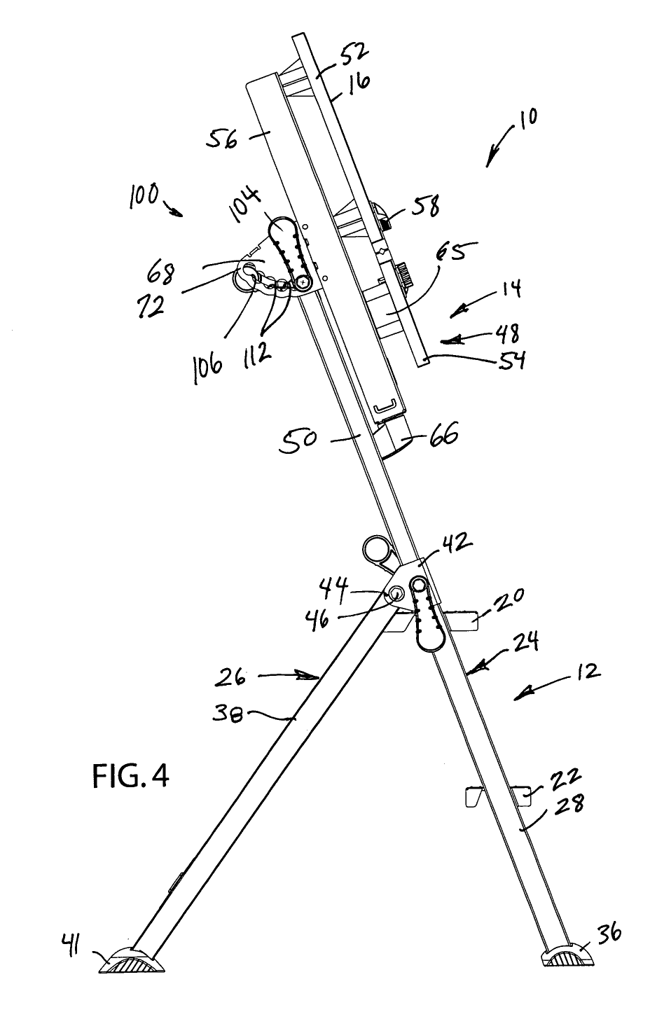

A plurality of steps are mounted on the work stand 10. In the illustrative embodiment, an upper step 20 and a lower step 22 are mounted on the base structure 12. The upper and lower steps 20, 22 are positioned generally under the table structure 14 when the table structure 14 is positioned in one of its operative positions. The table structure 14 is movable into an access position (see FIG. 4, for example) in which the steps 20, 22 are exposed to enable a worker to climb up and down the steps and to stand on either step with an erect posture.

FIG. 1 shows a perspective view of the work stand 10. The base structure 12 includes a pair of rigid support members 24, 26. The support member 24 includes a pair of legs 28. Each leg 28 in the illustrative work stand 10 is of hollow, tubular construction and includes a hollow tubular interior 30 and an open upper end 32. One end of each step 20, 22 is rigidly connected to a respective leg 28 of the support member 24. It is also possible to secure the steps 20, 22 with a locking pivotal joint to allow them to be folded flat with the legs 28. The steps 20, 22 hold the legs 28 rigidly in spaced relation to one another.

All or a portion of the upwardly facing support surfaces of the steps 20, 22 may be textured to include ribs 34 or other structures that prevent the feet of a worker from sliding off the step surface. Each step 20, 22 may have a closed cross-section (e.g., a tubular construction) or may have an open cross-section (e.g., an inverted U-shaped cross-section). The steps 20, 22 could also be flat or solid, if desired.

The steps 20, 22 and the legs 28 may be constructed of a variety of materials such as a metal (e.g., steel, aluminum), a plastic (e.g., a molded plastic) or any other material of suitable strength. The steps 20, 22 and the legs 28 may be separate structures that are formed individually and then assembled to one another. For example, in the instance in which the steps 20, 22 and legs 28 are each constructed of a metal, the steps 20, 22 may be secured to the legs 28 by welding, by fasteners (e.g., rivets, nuts and bolts) and/or by any other suitable means. Alternatively, the steps 20, 22 and legs 28 may be formed as separate molded plastic pieces which are then assembled to one another using, for example, fasteners, welding, adhesives and/or any other suitable means. The steps 20, 22 and legs 28 may also form part of a single integral structure. For example, in the instance in which the steps 20, 22 and legs 28 are each constructed of a molded plastic, the steps 20, 22 and legs 28 may be formed as integral parts of a single molded plastic structure.

A ground-engaging member 36 may be mounted on the ground-engaging free end of each leg 28. The ground-engaging member 36 may be constructed to protect floor surfaces from damage and/or to prevent sliding of the work stand 10 during use. Each ground-engaging member 36 may be constructed of a resilient, flexible material such as a rubber, a plastic or any other suitable material.

The support member 26 includes a pair of legs 38 and a cross member 40 rigidly connected therebetween. The cross member 40 may be constructed and positioned to support a foot of a worker when the work stand 10 is in use. For example, an upwardly facing surface of the cross member 40 may be textured to provide a non-skid foot support surface and the cross member 40 may be positioned at a convenient height and location to support the foot of a worker standing beside the work stand 10 in its deployed configuration (FIG. 1, for example). The worker may use the cross member 40 to rest a foot or to apply downward pressure to the work stand 10 to hold the work stand 10 in place while using the work stand 10 in any of its modes of operation.

The legs 38 may be similar in construction to legs 28. The cross member 40 may be constructed of a metal or plastic of suitable strength and may be secured to the legs 38 by means similar to those used for securing the steps 20, 22 to legs 28 or by any other suitable means. The ground-engaging ends of the legs 38 may be covered by ground-engaging members 41 which may be similar in construction to the ground-engaging members 36.

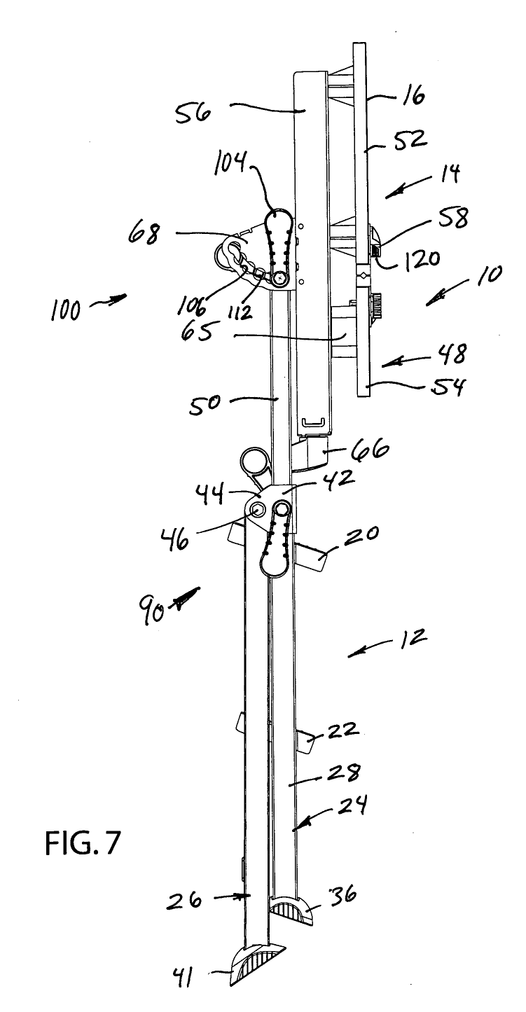

The support members 24, 26 are pivotally connected to one another for movement between an open base position (FIG. 1, for example) in which the base structure 12 is capable of standing in an upright position on a ground surface and a closed base position (FIG. 7, for example). The support members 24, 26 of the illustrative embodiment of the work stand 10 are pivotally connected to one another using a pair of brackets 42. Each bracket 42 is a generally U-shaped structure which is constructed of a material of suitable strength such as a metal (e.g., steel). Each bracket 42 is secured to an upper end of a respective leg 28 of the support member 24. Of course, it is possible to secure the bracket 42 to any point along the leg 28. Each bracket 42 may be secured to a respective leg 28 by welding, an adhesive or other suitable means. It can be appreciated that although the bracket 42 may be a separate structure from the leg 28 on which it is mounted, it is also contemplated that in some embodiments, a bracket structure can be formed integrally with a leg structure.

Each bracket 42 is shaped to include a pair of outwardly extending walls portions 44. In the example embodiment, the support member 26 is pivotally connected to support member 24 using a pair of fasteners 46 which may be provided by bolts or rivets, for example. A shaft portion of each fastener 46 extends through an opening in each wall portion 44 and through an opening through an upper end of the associated leg 38 of the support member 26.

Each bracket 42 may include a wall portion (not shown) that abuts the associated leg 38 when the base structure 12 is in its open base position to prevent further movement of the support member 26 with respect to the support member 24 in the opening direction. Alternatively, the upper ends of the legs 38 of the support member 26 may be shaped to abuttingly engage the associated leg 28 of the support member 24 when the base structure 12 is in its open base position to prevent further movement of the support members 24, 26 in their opening direction.

A table assembly 48 is movably mounted in the base structure 12. The table assembly 48 includes the table structure 14 and a pair of elongated rigid support elements 50. The table structure 14 includes a pair of table members 52, 54 and a pair of table mounting members 56. Each table member 52, 54 provides a portion of the table top surface 16 of the table structure 14 of the table assembly 48. In the illustrative embodiment, each table member 52, 54 is a substantially planar structure constructed of a material of suitable strength and durability to support a workpiece during use. Each table member 52, 54 may, for example, be constructed of a plastic (e.g., a molded plastic), a wood or wood-containing product (e.g., composition board, fiber board, plywood), or a metal. A plurality of workpiece holding brackets 58, 60 may be removably mounted on each table member 52, 54. Each table member 52, 54 may include a plurality of openings 62 in various locations for mounting the brackets 58, 60 on the table structure 14. Each bracket 58, 60 includes one or more downwardly extending posts (not shown) that mate with and are received within an opening 62 to removably mount a bracket 58 or 60 on a table member 52, 54. Each bracket 58, 60 can be lifted out of the opening(s) in which it is mounted and moved to another location on the table structure 14 as needed.

Each table mounting member 56 is an elongated rigid box-like structure that has a hollow interior. Each table mounting member 56 may be constructed of any material of suitable strength (e.g., a metal). In one embodiment, for example, each table mounting member 56 may be constructed of a sheet steel that has been punched and progressively shaped by stamping. Alternatively, each table mounting member 56 may be constructed of a molded plastic of suitable strength.

In the illustrative work stand 10, the table structure 14 includes a vise or clamping assembly for clamping a workpiece. The clamping function is provided in the example work stand 10 by fixedly mounting one of the table members on the table mounting members 56 and movably mounting the other table member on the table mounting members 56. Specifically, the table member 52 is rigidly and non-movably fixed to end portions of each table mounting member 56 and holds the table mounting members 56 in spaced relation to one another. The table member 52 may be secured to each table mounting member 56 by fasteners (e.g., bolts, rivets) or by any other suitable means.

It can be appreciated that this is illustrative only and not intended to be limiting. For example, in other embodiments, both table members 52, 54 can be movably mounted on the table mounting members 56 for clamping movement between open and closed positions.

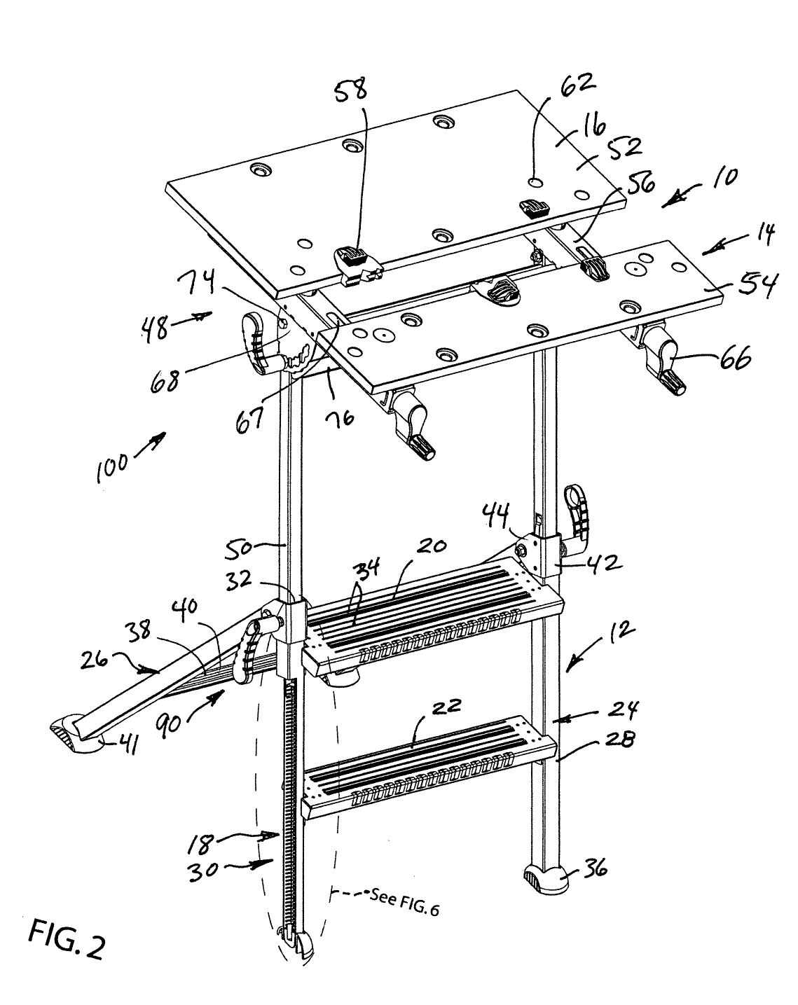

The table member 54 is movably mounted to the opposite end portions of the table mounting members 56 of the table structure 14 for movement with respect to the table member 52 between a closed table top position (see FIG. 1, for example) and an open table top position (see FIG. 2, for example).

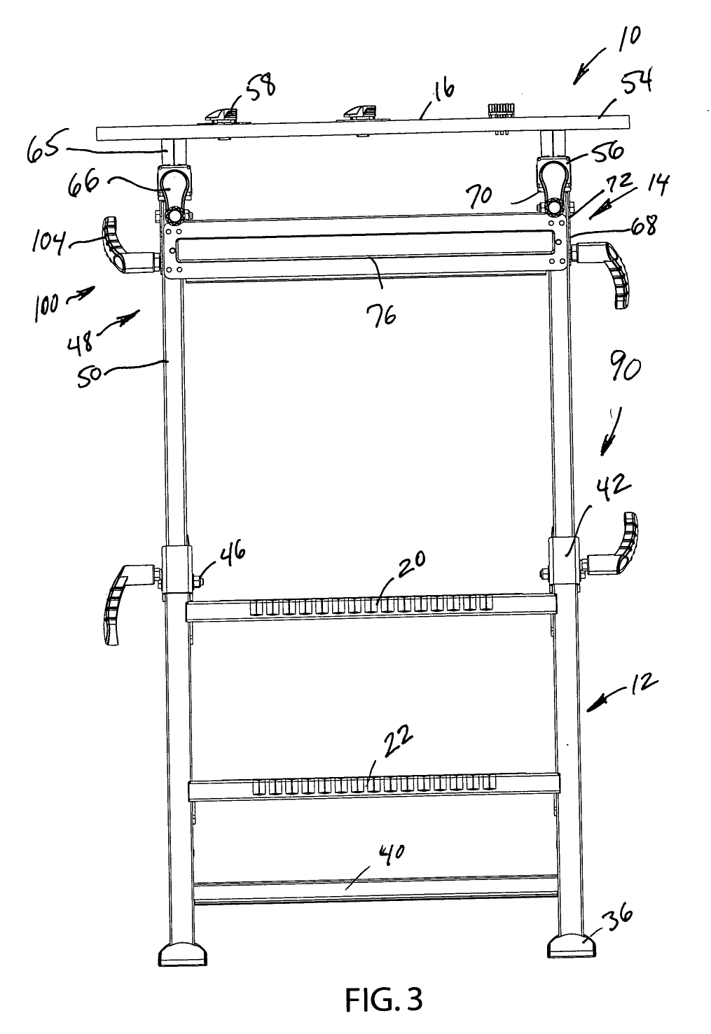

Movement of the table member 54 with respect to the table member 52 is accomplished by a table member moving mechanism mounted on the table structure 14. The table member moving mechanism may be in the form of a pair of elongated threaded members (not visible) that are rotatably mounted on respective table mounting members 56. A free end of each threaded member extends outwardly of an opening (not visible) in an end of a respective table mounting member 56. A crank-type handle 66 is mounted on the free end of the threaded member. A threaded shaft portion of each threaded member is supported within the interior of the associated table mounting member 56 for bidirectional rotational movement with respect to the table mounting member 56 and the table member 52. The threaded shaft of each threaded member is threadedly engaged with a threaded portion of a support structure 65 (see FIG. 3). Each support structure 65 extends upwardly through a slot 67 in a respective table mounting member 56 and is secured to a downwardly facing surface on the table member 54. The support structures 65 and the threaded shafts of the table member moving mechanism are threadedly inter-engaged such that rotation of the shafts in first and second rotational directions by turning the handles 66 moves the movable table top member 54 toward and away from the non-movable table top member 52, respectively.

The table structure 14 is pivotally mounted to the support elements 50 for angular movement through a range of operative angular positions to adjust the angle of the table top surface 16 with respect to the ground surface. The table structure 14 is also pivotally mounted to the support elements 50 for angular movement into an access position in which the steps 20, 22 are exposed and accessible for the worker to climb up and down and/or to stand on. The table mounting members 56 are pivotally mounted to upper ends of the support elements 50 by means of brackets 68.

Each illustrative bracket 68 is a rigid, generally L-shaped structure shaped to include an upper wall portion 70 (see FIG. 3) and a side wall portion 72. Each bracket 68 may be constructed of a metal, a molded plastic or other material of suitable strength. The upper wall portion 70 of each bracket 68 is secured to a respective table mounting member 56. The side wall portion 72 of each bracket 68 is pivotally mounted to an upper end of an associated support element 50 by a fastener 74 which extends through an opening in the wall portion 72 and into the associated support element 50.

Each support element 50 is an elongated, rigid structure and may be similar in construction to legs 28 or 38. A cross member 76 is rigidly secured between the support elements 50 and is operable to hold the support elements 50 in spaced relation to one another and to rigidify and strengthen the table assembly 48 and the work stand 10. The cross member 76 may be of similar construction to cross member 40 and may be secured to the support elements 50 in a manner similar to the manner in which the cross member 40 is secured to the legs 38.

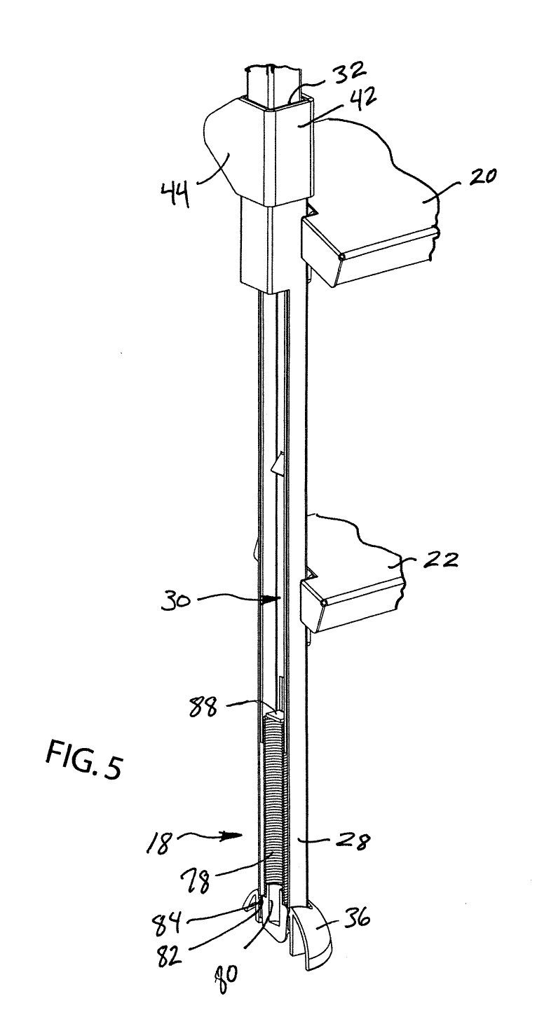

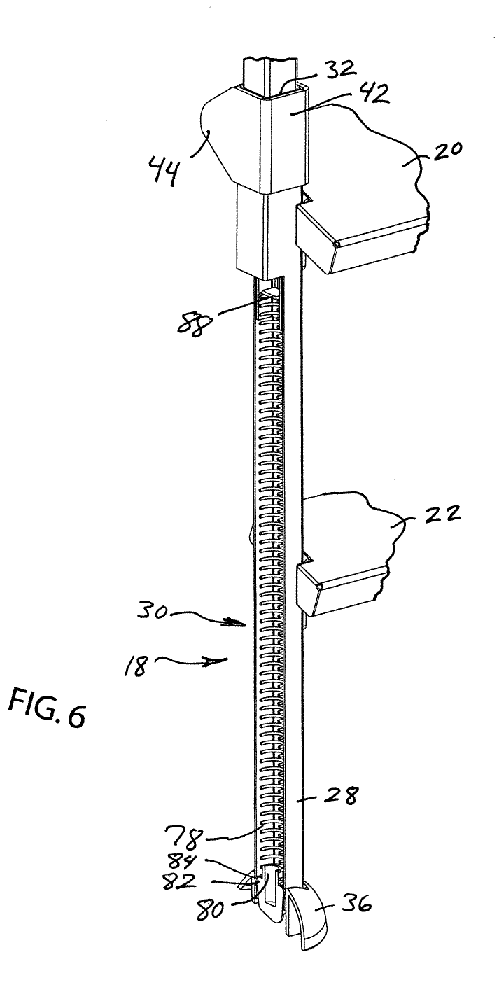

The pair of support elements 50 are movably mounted in a pair of recesses formed in the base structure 12. The recesses are provided by the open end 32 of the legs 28 and the hollow tubular interior 30 of each leg 28. The legs 28, 38 and the support elements 50 in the example work stand 10 each have a generally rectangular transverse cross-section. The support elements 50 are telescopically engaged with the legs 28 (see FIGS. 5 and 6, for example).

The spring mechanism 18 may be provided by a pair of coil springs 78. Each coil spring 78 is disposed within the interior 30 of a respective leg 28 of the support member 24. The support elements 50 and the coil springs 78 are operatively inter-engaged such that as the table structure 14 is lowered, the telescopic movement of the support elements 50 inwardly into respective recesses compresses the coil springs 78. As the table structure 14 is raised, each coil spring 78 applies a spring force to the associated support element 50 which force assists the raising movement of the table structure 14.

FIGS. 5 and 6 illustrate the operative engagement between a coil spring 78 of the spring mechanism 18 and a support element 50 of the table assembly 48. It can be appreciated that the ground-engaging member 36 includes a upwardly extending post structure 80 constructed and arranged to fit within an interior portion of the leg 28. The post structure 80 may be retained within the leg 28 by interference fit, with the use of an adhesive, and/or with a fastener. Alternatively or additionally, the post structure 80 may be shaped to include a protruding structure 82 which snap fits into locked relation with a recess or opening 84 formed within a wall portion of the leg 28 when the post structure 80 is inserted in the end of the leg 28.

A lower end of the coil spring 78 abuts a top portion of the post structure 80. An upper end of the coil spring 78 extends into a recess formed in the associated support element 50 and abuts a downwardly facing surface provided by a wall structure 88 disposed within the recess. In the example embodiment, the support element 50 has a generally tubular construction. In an instance in which the support element 50 is constructed of a sheet metal, a side wall portion of the support element 50 may be punched out and shaped to form the wall structure 88.

It can be appreciated from a comparison of FIGS. 5 and 6 that as the table structure 14 is moved with respect to the base structure 12 from a relatively higher position (FIG. 6) to a relatively lower position (FIG. 5), movement of the support element 50 into the interior 30 of the associated leg 28 compresses the coil spring 78 between the wall structure 88 and the post structure 80. When the table structure 14 is raised, the spring tension of the compressed coil spring 78 assists the worker in raising the table structure 14 with respect to the base structure 12.

The amount of spring force applied by a spring mechanism to a table structure in a particular embodiment of a work stand depends on the characteristics of the spring mechanism selected. In some embodiments, for example, a spring mechanism can be constructed to provide sufficient force to raise the table structure from its lowest operating position to its highest operation position without the need for any additional upwardly directed force to be applied by the worker adjusting the work stand.

A releasable table locking mechanism 90 is operatively engaged with the table structure 14 and movable between a locking position in which the table locking mechanism 90 releasably locks the table structure 14 in an operative table top position and a releasing position in which the table structure 14 can be raised and lowered through its range of operative table top positions.

In the example embodiment, the table locking mechanism 90 is provided by a pair of locking members what are mounted on respective brackets 42 on the legs 28 and operatively engaged with respective support elements 50 on the table assembly 48. Each lock member includes a handle 94 and a threaded shaft (not visible) that is rigidly attached to the handle 94. The threaded shaft is threadedly engaged with a threaded channel or passageway formed on the side of the bracket 42. The passageway opens into the hollow tubular interior 30 of the leg 28. Rotation of the handle 94 in first and second rotational directions causes the threaded shaft to move toward and away from the support element 50 disposed in the interior 30 of the associated leg 28.

The table assembly 48 can be releasably locked in fixed relation to the base structure 12 by moving the threaded faster toward the support element 50 until the free end of the shaft abuttingly engages the side of support element 50. The handle 94 can be rotated in the locking direction to tighten the abutting engagement sufficiently to hold the table assembly 48 in place with respect to the base structure 12. The handle can be rotated in the opposite direction to move the threaded shaft in a releasing direction out of abutting engagement with the support element 50 to release the support element 50 for vertical movement with respect to the base structure 12.

Of course, as will be appreciated by those of ordinary skill in the art, any locking mechanism can be used. For example, the support elements 50 and the legs 28 could be provided with slots or holes that are engaged by a pin or tab when aligned. The pin or tab can be controlled manually or by the handle 94 and could be spring biased if desired.

As mentioned, the table structure 14 is mounted on the base structure 12 for angular movement through a range of operative angular table top positions with respect to the base structure to adjust the angle of the table top surface with respect to the ground surface so that a workpiece can be supported on an angled table top surface. The work stand 10 further comprising a releasable angular locking mechanism 100 operatively engaged with the table structure 14 and movable between a locking position in which the angular locking mechanism releasably locks the table structure 14 in an operative angular position and a releasing position in which the table structure 14 can be angularly moved through its range of operative angular positions.

The angular locking mechanism 100 is comprised of a pair of angular locking members which may be similar in construction and operation to lock members. Each angular locking member is mounted on a respective support element 50. Each angular locking members includes a handle 104 and a threaded shaft (not visible). The threaded shaft is threadedly engaged with a threaded opening formed in a portion of the associated support element 50. The threaded shaft of each angular locking member extends through an arcuate slot 106 formed through the bracket 68. The slot 106 includes a series of spaced, widened areas 112 which form openings sized to receive a large diameter structure (large relative to the diameter of the threaded shaft) on the handle 104 or between the threaded shaft and the handle 104. The widened areas 112 are spaced along the arcuate slot 106 to provide a series of discrete angular table top positions.

To lock the table structure 14 in a particular angular position, each handle 104 is rotated a locking or tightening direction to cause the large diameter structure thereon to enter a widened area 112 in the slot 106. The presence of the large diameter structure formed on the handle 104 within a particular widened area 112 of the slot 106 locks the table structure 14 in a selected angular position. Each angular locking member is unlocked by rotating the handle 104 in the opposite or releasing direction until the large diameter structure of the handle moves out of locking engagement with the widened area 112 in which it was disposed. The unlocked table structure 14 can be pivoted to change the angle of the table structure 14 and the table top surface 16 thereof with respect to the ground surface.

In the illustrative embodiment, the table structure 14 is moved into its access position by moving the table structure angularly with respect to the base structure (see FIG. 4). The table structure 14 can be locked in the access position using the angular locking members 102.

Operation

The work stand 10 can be used in a variety of modes including a work table or bench mode to support a workpiece and a step ladder or step stool mode to support the worker to enable the worker to reach structures and locations that are otherwise out of reach.

The height of the table top surface 16 can be lowered with respect to the ground surface by releasing the table locking mechanism 90 and pushing downwardly on the table top surface 16. Downward movement of the table structure 14 compresses the coil springs 78. The worker can relock the table structure 14 while holding the table structure 14 at the desired level. To raise the table top surface 16, the worker releases the table locking mechanism 90. The spring force of the coil springs 78 raises, or assists the raising of, the table structure 14 with respect to the base structure 12. The worker can manually stop the upward movement of the table structure 14 when the table structure 14 reaches its desired height and re-lock the table structure 14 with respect to the base structure 12. The work stand 10 can be adjusted to hold a workpiece at a convenient height for a person standing by the work stand 10. The height of the table top surface 16 can be adjusted to accommodate different worker heights and work pieces of a wide range of sizes.

The clamping mechanism can be operated to hold a workpiece between the table members 52, 54 or between a pair of brackets 58 or 60 on the table top surface 16. Specifically, a workpiece can be gripped between the table members 52, 54 by placing the workpiece between the table top members 52, 54 when the members 52, 54 are in an open position and moving each movable table top member 54 toward the closed table top position so that the table top members 52, 54 abut opposite side of the workpiece.

In the instance in which a pair of brackets (for example, brackets 58) are used to hold a workpiece on the table top surface 16, it can be appreciated that each bracket 58 includes a wall portion 120 that extends upwardly from the table top surface 16. The table top members 52, 54 and the pair of brackets 58 are configured to enable a workpiece to be gripped by placing the workpiece on the table top surface 16 with the table top members 52, 54 in an open position and moving each movable table top member toward the closed table top position thereof so that the brackets 58 abut opposite sides of the workpiece.

The work stand 10 may be used as a ladder by locking the table structure 14 in an access position (FIG. 4). The steps 20, 22 are exposed and accessible so a worker can stand on either step 20, 22 with an erect posture. The upper step 20 may be constructed to be wider than the lower step 22 to facilitate standing on the upper step 10 with an erect posture while working.

When the table structure 14 is in its access position, it is positioned to enable a worker standing on the upper step 20 to lean one or both legs or knees against the table structure 14 to help the worker maintain the worker's balance while standing on the upper step 20. When the table structure 14 is in its access position, a worker standing on the upper step 20 or the lower step 22 can grasp the table structure 14 with one or both hands to help the worker maintain the his or her balance while standing on or climbing up or down from the upper or lower step.

The table top surface 16 may be substantially flat as illustrated, although any shape may be used when constructing other embodiments of the work stand. The work stand 10 is shown in its folded condition for storage in FIG. 7. When the work stand 10 is in its folded position, the base structure 12 is in its closed position. The legs 28, 38 are substantially parallel to one another when the base structure 12 is in the closed base position. When the work stand 10 is folded, the table structure 14 is in a position in which the table top surface 16 is substantially parallel to the legs 28, 38 so that the work stand 10 is in a substantially flat condition for storage.

Thus, while the invention has been disclosed and described with reference with a limited number of embodiments, it will be apparent that variations and modifications may be made thereto without departure from the spirit and scope of the invention and various other modifications may occur to those skilled in the art. Therefore, the following claims are intended to cover modifications, variations, and equivalents thereof.

1. A work stand, comprising:
a base including at least two legs; and
a table structure supported by the base and including a table top surface and a rigid support element, wherein the rigid support element is movably coupled to at least one leg;
a biasing mechanism connected to the at least one leg and the rigid support element to urge the table structure to move generally vertically with respect to the base; and
a locking mechanism connected to at least one of the rigid support elements and the leg to lock the table structure in a set position with respect to the base.

2. The work stand of claim 1, wherein the at least one leg is hollow and the biasing mechanism is disposed within the hollow leg, wherein the rigid support element is received within the leg.

3. The work stand of claim 1, wherein the biasing mechanism is a spring and the rigid support element has an end that bears on an end of the spring.

4. The work stand of claim 1, wherein the rigid support element comprises a pair of spaced rigid support elements, and the at least two legs comprise a first set of spaced rigid support members and a second set of spaced rigid support members, wherein the pair of spaced rigid support elements telescope with the first set of spaced rigid support members.

5. The work stand of claim 4, wherein the second set of spaced rigid support members are coupled to the first set of spaced rigid support members and are movable between an open position and a closed position.

6. The work stand of claim 1, wherein the locking mechanism comprises a handle and a shaft supported by the handle movable between a locked position that abuts the rigid support element and an movable position that is spaced from the rigid support element.

7. The work stand of claim 1, wherein the table structure includes a first table member and a second table member movable with respect to the first table member.

8. The work stand of claim 1, further comprising a clamping assembly mounted to the table structure.

9. The work stand of claim 1, further comprising a step coupled to the base.

10. The work stand of claim 1, wherein the table top surface and the rigid support element are pivotally mounted to each other.

11. The work stand of claim 1, further comprising at least two steps coupled to the base and positioned under the table top surface, wherein the table top surface is tiltable to a position in which the steps are accessible to an upright user.

12. A work stand, comprising:
a base including a plurality of support members, at least two of the support members being generally parallel and spaced apart;
a table structure supported by the base and including a table top surface, wherein the table structure is pivotally mounted with respect to the base and movable between a work position and a step access position; and
at least two steps supported between the spaced apart parallel support members, the steps having horizontal support surfaces positioned under the table top surface when the table structure is in the work position and all steps being accessible to an upright user when the table top is in the step access position to provide a stable weight bearing support surface.

13. The work stand of claim 12, wherein the at least two steps include a lower step and an upper step that is wider than the lower step.

14. The work stand of claim 12, wherein the steps have a textured upper surface.

15. The work stand of claim 12, further comprising a locking mechanism coupled to the table structure that allows the table top surface to be selectively positioned in a plurality of angular positions.

16. The work stand of claim 12, wherein the table structure includes a support element that is connected to the base to allow selective movement between the table structure and the base.

17. The work stand of claim 16, wherein at least some of the support members are hollow and the support element telescopes with the hollow support members.

18. The work stand of claim 17, wherein a biasing mechanism is disposed between the support element and the hollow support members to urge the table structure to move in a vertical direction with respect to the base.

19. The work stand of claim 12, wherein the base has four support members, including two pairs of generally parallel spaced apart members, wherein each pair is movably positioned with respect to each other between a parallel closed position and an angled open position.

20. A work stand, comprising:
a base structure constructed and arranged to stand in an upright position on a ground surface;
a table structure having a table top surface configured to support a workpiece and being mounted on said base structure for raising and lowering movement through a range of operative table top positions with respect to said base structure to adjust the height of said table top surface with respect to the ground surface;
a releasable table locking mechanism operatively engaged with said table structure and movable between a locking position in which said table locking mechanism releasably locks said table structure in an operative table top position and a releasing position in which said table structure can be raised and lowered through the range of operative table top positions thereof;
a spring mechanism operatively engaged with said table structure operable to apply a force to said table structure which tends to raise said table structure with respect to said base structure to assist a raising movement of the table structure with respect to said base structure; and
a lower step and an upper step mounted on said base structure, said upper and lower steps being positioned generally under said table structure when said table structure is in an operative position thereof;
said table structure being movable into an access position in which said steps are exposed to enable a worker to climb up and down said steps and to stand on either step with an erect posture.
